(19) United States
(12) Patent Application Publication
(10) Pub. No.: US 2010/0054990 A1
(43) Pub. Date: Mar. 4, 2010

(54) GAS CONTAINER CORROSION PROTECTION

(76) Inventor: Mark Stephen Williams, Warwick (GB)

Correspondence Address: THE SMALL PATENT LAW GROUP LLP, 225 S. MERAMEC, STE. 725T, ST. LOUIS, MO, 63105, US

(21) Appl. No.: 12/548,367

(22) Filed: Aug. 26, 2009

(30) Foreign Application Priority Data
Aug. 27, 2008 (GB) 0815476.7

(51) Int. Cl. C23F 11/00; B65D 85/00; B23P 25/00

(52) U.S. Cl. 422/7; 206/6; 29/458

(57) ABSTRACT

A gas container and method of maintaining gas in a container and assembling a gas container are provided. The gas container includes at least a first section and a second section with the first and second sections being substantially hollow and movable relative to each other and a liquid seal for sealing gas within the container. The liquid seal is disposed between the first section and the second section, wherein a first anti-corrosion coating is provided so as to float on the surface of the liquid in the liquid seals, such that in use, the first anti-corrosion coating is caused to be applied to at least a portion of the second section during motion of the second section relative to the first section.

### CROSS REFERENCE TO RELATED APPLICATIONS

This application claims priority to and the benefit of the filing date of Great Britain Patent Application No. GB 0814476.7, filed Aug. 27, 2008, which is hereby incorporated by reference in its entirety.

### BACKGROUND OF THE INVENTION

The present invention relates to the storage of gas, and more particularly to techniques for preventing or reducing corrosion in gas containers.

It is well known that certain gases, especially combustible gases for domestic or industrial use, and other volatile gases, need to be safely and securely stored, typically by means of traditional bell holders or enlargeable metal gas holder (hereafter “gas holders”) that use a liquid such as water to provide seals for containing the gas.

Gas holders are essential to the continuous supply of gas to customers during periods of high demand. There are currently numerous gas holders deployed, of which many are the water-sealed type. These operate in a harsh environment, involving raising from and lowering into a tank of water twice a day for the majority of the year, as they are filled and emptied.

The gas holders are conventionally maintained by stripping the existing multi layer paint system and reapplying when required with a similar multi coat paint system. The normal life of the anti-corrosive paint system is ten to fifteen years.

A problem with known systems is that the water based seals, in which a part of a (substantially cylindrical) upper container is in contact with water, are subject to corrosion and need to undergo frequent maintenance, which includes removing and reapplying an anticorrosion coating.

A conventional water-sealed type gas holder 2, and the process for maintenance, is depicted in FIGS. 1-4 (PRIOR ART). The holder 2 comprises a base section 4 and two upper sections 6, 8. At the two horizontal rings 10, 12 of the holder 2 are disposed liquid (water) seals (not shown). The typical process for the painting of the gas holder 2 with anti-corrosive paint is as follows.

1. Set up site—Average job duration 16 to 26 weeks.

2. Remove majority of existing coating using high pressure (HP) or ultra high pressure (UHP) water jetting equipment 14.

3. Collect removed coating on netting for disposal as special waste.

4. Degrease holder surface with detergent wash to produce bare metal surface 16.

5. Apply one coat of primer (two-pack epoxy aluminium).

6. Apply two coats of finish (water borne vinyl acrylic).

The process is repeated for each of two horizontal rings 10, 12 of the holder 2. A Mobile Elevated Working Platform (MEWP) or scaffold is required to work at height on the rings 10, 12.

In conventional methods, problems associated with preparation include:

Containment and removal of high volumes of special waste, e.g., removed coating materials plus debris netting, used Personal Protective Equipment (PPE) (disposable).

Potential noise pollution during surface preparation—HP and UHP jetting units, compressors, site generators, MEWPs etc.

High level of personnel “health and safety” control measures—PPE for UHP and HP equipment use, noise controls, special waste procedures, waste confinement (screening), collection (keeping debris netting in place and emptying), storage (bunding, security) and inhalation.

Time consuming, i.e., depending on condition of existing paint and size of holder 2, between one and five days for 2 horizontal plate rings 10, 12.

In conventional methods, problems associated with coating include:
Multiple coats of different materials require:
   Manual application spray, brush application;
   Large volume to transport and store (on site with bunding);
   Long process to apply all coats (e.g., Usually prep 2 rings, degrease and allow to dry, prime and allow to cure, apply first finish coat allow to cure, allow second finish coat, allow to cure, raise holder then repeat cycle. Typically there is a minimum of 4 days per two rings of plates (working from ground).
The two-pack epoxy primer becomes waste if not used in pot life. Material has limited use time before it cures. If paint is mixed and it rains or any is left at the end of a shift, this goes into the waste stream.
Restrictive weather and temperature tolerance. Materials have upper and lower temperature limits and maximum humidity levels for application that require stringent monitoring

In conventional methods, problems associated with performance include:
Coating breakdown affects surrounding area. Any breakdown in the coating system will allow tank/rain water to penetrate underneath the surrounding coating, causing disbonding of sheets of material, for example, as shown in FIG. 2.
Maintenance repairs require full surface preparation and reapplication of all coating layers. Areas surrounding damaged require preparation to remove all potentially disbonded material. The full paint system then needs to be applied, involving multiple curing times. It is not adequate to overcoat what's already there. There is potential for hidden areas of coating breakdown. A high degree of preparation for key is a requisite.

Varying rate of deterioration of the paint system this is affected by localised and prevailing conditions (salt water/winds), original design and material specification of holder 2. It is known to replace the ‘water seal’ of a gas holder with an alternative ‘seal’ that is not exposed to atmosphere. Such techniques fail to provide an anti-corrosion coating on to the gas holder by use of the existing ‘water seal’.

It is also known in certain (non-maintenance) contexts to try to eliminate tank corrosion immediately in contact with the water seal by eliminating oxygen from the seal, or to reduct water vapors from entering the stored gas. (This was important when gas was manufactured locally.) Such techniques fail to provide an alternative to original painting methods.

### BRIEF DESCRIPTION OF THE INVENTION

In accordance with one embodiment, a gas container is provided that includes at least a first section and a second section. The first and second sections are substantially hollow and movable relative to each other. The gas container further includes a liquid seal for sealing gas within the container. The liquid seal is disposed between the first section and the second section. The gas container also includes a first anti-corrosion coating floating on the surface of the liquid in the liquid seal. The first anti-corrosion coating is applied to at least a portion of the second section during motion of the second section relative to the first section.

In accordance with another embodiment, a method of assembling a gas container is provided. The method includes providing a first substantially hollow section and providing a second substantially hollow section. The method further includes providing a liquid seal for sealing gas within the container. The liquid seal is disposed between the first section and the second section. The method also includes providing a first anti-corrosion coating so as to float on the surface of liquid in the liquid seal. The method additionally includes causing the first and second sections to engage or move relative to each other, such that the first anti-corrosion coating is caused to be applied to at least a portion of the second section, during motion of the second section relative to the first section.

In accordance with yet another embodiment, a method of maintaining a gas container is provided. The container includes a first section and a second section, with the first and second section being substantially hollow and movable relative to each other. The container further includes a liquid seal provided for sealing gas within the container. The liquid seal is disposed between the first section and the second section. The method includes providing a first anti-corrosion coating so as to float on the surface of the liquid of said liquid seal. The method further includes causing the first and second parts to engage or move relative to each other, wherein the first anti-corrosion coating is caused to be applied to at least a portion of the second section, during motion of the second section relative to the first section.

### BRIEF DESCRIPTION OF THE DRAWINGS

FIG. 1 is a diagram showing a conventional gas holder;

FIG. 2 is a diagram illustrating maintenance of a conventional gas holder;

FIG. 3 is a diagram showing a portion of a conventional gas holder;

FIG. 4 is a diagram showing an enlarged view of a portion of a conventional gas holder;

FIG. 5 shows schematically in cross-section a gas holder and techniques for maintenance, according to a first embodiment of the invention, (a) complete view showing movable sections, and (b) a liquid sealing ring in detail; and

FIG. 6 shows a gas holder and techniques for maintenance, according to a second embodiment of the invention, (a) complete view showing movable sections, and (b) schematically in cross-section showing liquid sealing in detail.

### DETAILED DESCRIPTION OF THE INVENTION

Various embodiments of the present invention provide improved techniques for storage of gases.

According to one aspect of the present invention there is provided a gas container, comprising: at least a first section and a second section, the first and second sections being substantially hollow and movable relative to each other; a liquid seal for sealing gas within the container, the liquid seal being disposed between the first section and the second section; wherein a first anti-corrosion coating is provided so as to float on the surface of the liquid in said liquid seals; whereby, in use, the first anti-corrosion coating is caused to be applied to at least a portion of said second section during motion of the second section relative to the first section.

Preferably, the second section has a second anti-corrosion coating on at least a portion thereof. Preferably, the first anti-corrosion coating is caused to be applied to at least a part of said second anti-corrosion coating.

In one embodiment, the gas container comprises a number of further sections configured in a telescopic arrangement, whereby the volume of the gas container is variable; and wherein one of said liquid seals is provided between adjacent sections. Preferably, the first and/or further second sections have the second anti-corrosion coating on at least a portion thereof.

Preferably, the second anti-corrosion coating comprises a cured coating applied by painting or spraying. Preferably, the first anti-corrosion coating comprises a floatable anti-corrosion coating, e.g., Floatcoat®.

According to another aspect of the present invention there is provided a method of assembling a gas container, comprising: providing a first substantially hollow section; providing a second substantially hollow part; providing a liquid seal for sealing gas within the container, the liquid seal being disposed between the first section and the second section; providing a first anti-corrosion coating so as to float on the surface of liquid in said liquid seals; and causing the first and second sections to engage or move relative to each other, whereby the first anti-corrosion coating is caused to be applied to at least a portion of said second section, for example during motion of the second section relative to the first section.

Preferably, the second section has a second anti-corrosion coating on at least a portion thereof. Preferably, the first anti-corrosion coating is caused to be applied to at least a part of said second anti-corrosion coating.

In one embodiment, the there are provided a number of further sections configured in a telescopic arrangement, whereby the volume of the gas container is variable; and wherein one of said liquid seals is provided between adjacent sections. Preferably, the first and/or further second sections have the second anti-corrosion coating on at least a portion thereof.

Preferably, the second anti-corrosion coating comprises a cured coating applied by painting or spraying.

Preferably, the first anti-corrosion coating comprises a floatable anti-corrosion coating, e.g., Floatcoat®.

According to another aspect of the present invention there is provided a method of maintaining a gas container, the container comprising a first section and a second section, the first and second section being substantially hollow and movable relative to each other; a liquid seal being provided for sealing gas within the container, the liquid seal being disposed between the first section and the second section, the method comprising: providing a first anti-corrosion coating so as to float on the surface of the liquid of said liquid seals; causing the first and second parts to engage or move relative to each other, whereby the first anti-corrosion coating is caused to be applied to at least a portion of said second section, for example during motion of the second section relative to the first section.

Preferably, the second section has a second anti-corrosion coating on at least a portion thereof. Preferably, the first anti-corrosion coating is caused to be applied to at least a part of said second anti-corrosion coating.

In one embodiment, the gas container comprises a number of further sections configured in a telescopic arrangement, whereby the volume of the gas container is variable; and wherein one of said liquid seals is provided between adjacent sections. Preferably, the first and/or further second sections have the second anti-corrosion coating on at least a portion thereof.

Preferably, the second anti-corrosion coating comprises a cured coating applied by painting or spraying. Preferably, the first anti-corrosion coating comprises a floatable anti-corrosion coating, e.g., Floatcoat®.

The techniques according to the invention move away from multiple paint layers to a ‘self healing’ two-coat system that is much healthier, quicker and easier to apply and maintain.

The first application requires a similar level of surface preparation as conventional painting to remove the existing coating materials. This high level of preparation is not required for future maintenance coatings. The first coat material is roller applied to the prepared surface of the gas holder to a thickness of, for example, about 100 microns. This coat is allowed to cure fully after completion prior to the final coating material being used.

The second coat material does not require manual application to the holder surface It is “floated” on the water surface of the gas holder seals and adheres to the surface as the holder is raised and lowered. This second coat is a non setting gel type material which, once adhered, remains on the holder surface to protect it from corrosion.

Various embodiments of the invention may provide the following:
No risk to human health or the environment. The invention has many health, safety and environmental benefits for the workforce and the local community.
Application is extremely tolerant to adverse weather I temperatures.
Trials show excellent corrosion protection achieved through a single application. Average job duration 8 to 13 weeks.

Further, various embodiments of the invention may provide with respect to Safety and Health the following:
Only one roller applied coat. Only a single coat requires manual application, reducing the physical effort and time of application by a factor of three over the conventional method.
Second coat applied from holder tank and cups. The second material effectively apples itself as the holder is raised and lowered.
Less material required reducing manual handling and use of portable plant.
The process reduces health hazards and noise exposure.
No repeat preparation required in subsequent years. Removal of the need for high specification surface preparation for future applications significantly reduces health hazards and noise exposure for operatives and the local community.

Further, various embodiments of the invention may provide with respect to Environment the following:
System is “Self Healing” requires minimal maintenance repairs. Any areas of mechanical damage to the coatings will re-coat with the second non setting material and prevent corrosion.
No subsequent stripping of degraded paint film, reducing future waste generation.
Significant reduction in material usage, reducing manual handling and the carbon footprint for transportation and application.
Material is environmentally friendly.
Job durations reduced.

It has been found that the various embodiments provide a 50% saving compared with conventional maintenance painting costs. There is an estimated 75% saving in future maintenance coating costs where the initial high standard of preparation will not be required.

Various embodiments of the present invention also seek to provide a complete anti-corrosion protection to the whole gas holder side sheeting whilst at the same time including (optionally) a color pigment to enhance the appearance of the gas holder to suit local aesthetics, i.e., an alternative ‘painting’ system.

Embodiments of the invention will now be described in detail, by way of example, with reference to the accompanying drawings.

In the description and drawings, like numerals are used to designate like elements. Unless indicated otherwise, any individual design features and components may be used in combination with any other design features and components disclosed herein.

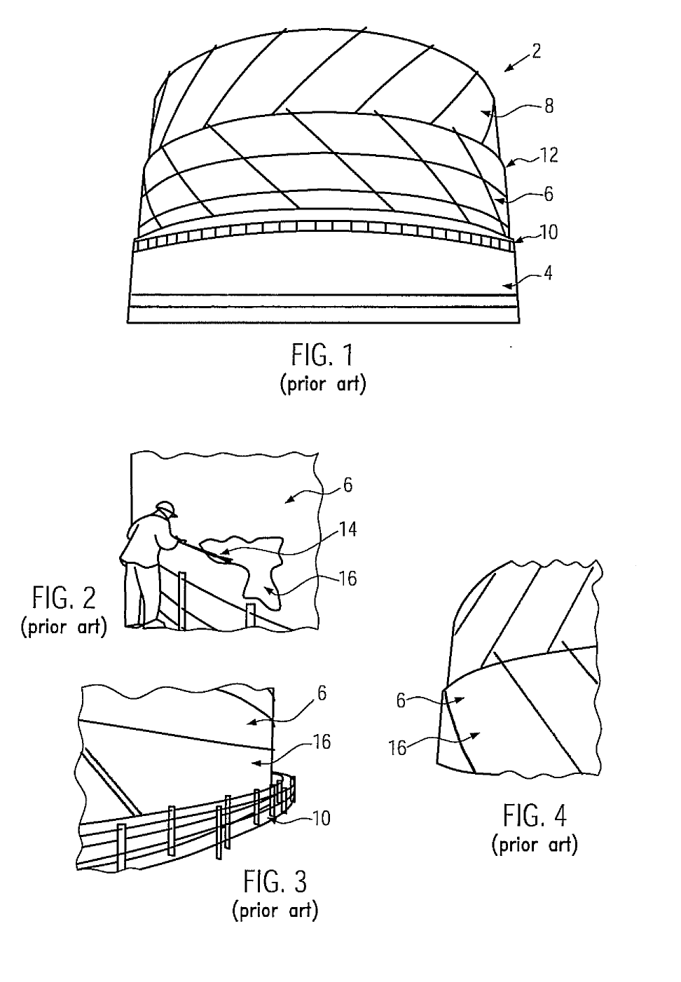

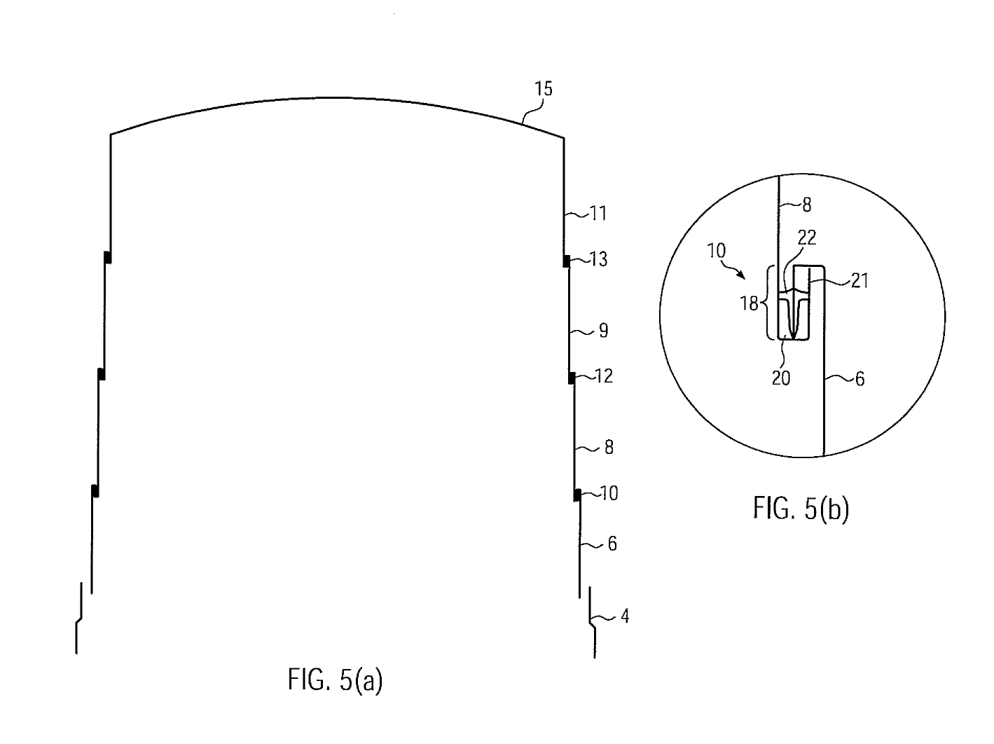

FIG. 5(a) shows schematically in cross-section a gas holder and techniques for maintenance, according to a first embodiment of the invention, in complete view showing movable sections. The construction of the gas holder 2 is the same as in FIGS. 1 to 4, except as described below. In this case, as well as base section 4, there are four upper sections 6, 8, 9 and 11, having associated rings (liquid seals) 10, 12, 13. The upper section 11 has a dome 15. Each section 6, 8, 9, 11 is capable of containing a substantial quantity of gas, and the each section is constructed an arranged so as to be movable vertically in telescopic fashion in relation to an adjacent section, dependent on the amount of gas stored or to be stored in the gas holder 2.

FIG. 5(b) shows a liquid sealing ring 10 in more detail. For each of the sections, including sections 6 and 8, there is optionally but preferably provided a first anti-corrosion coating as described above in the process described with reference to FIGS. 1 to 4, i.e., one coat of primer (two-pack epoxy aluminium), followed by two coats of finish (water borne vinyl acrylic). Suitably, the first anti-corrosion coating comprises a coating available under the trade name Performance 105. This is suitably applied by roller. In this embodiment, within the ring 10 a liquid seal 18 is provided by a reservoir of water 20 in which an upper limb 21 of section 6 is immersed. The upper limb is movable vertically in relation to the water 20 during increases and decreases in the volume of the gas holder 2.

According to various embodiments of the invention, an anti-corrosion coating 22 is provided. The anti-corrosion coating 22 comprises a material that will float on the water 20, and is suitably a floatable anti-corrosion coating available under the trade name Floatcoat®. The anti-corrosion coating 22 is applied from a holder tank and cups (not shown), i.e., all applied at ground/tank level from an applicator (not shown). This can be achieved in 1 day for all 3 sections in a typical installation.

In this embodiment, water is used as the liquid seal.

In this embodiment, Floatcoat® is used as the anti-corrosion coating 22; however, it will be appreciated by persons skilled in the art that other liquids may be used. The requirement is only that the anti-corrosion coating 22 has a lower density than the liquid (water), so as to float thereon. Suitably, the anti-corrosion coating 22 comprises an organic composition containing a corrosion inhibitor. Suitably, the organic composition is a naphthenic mineral oil based composition.

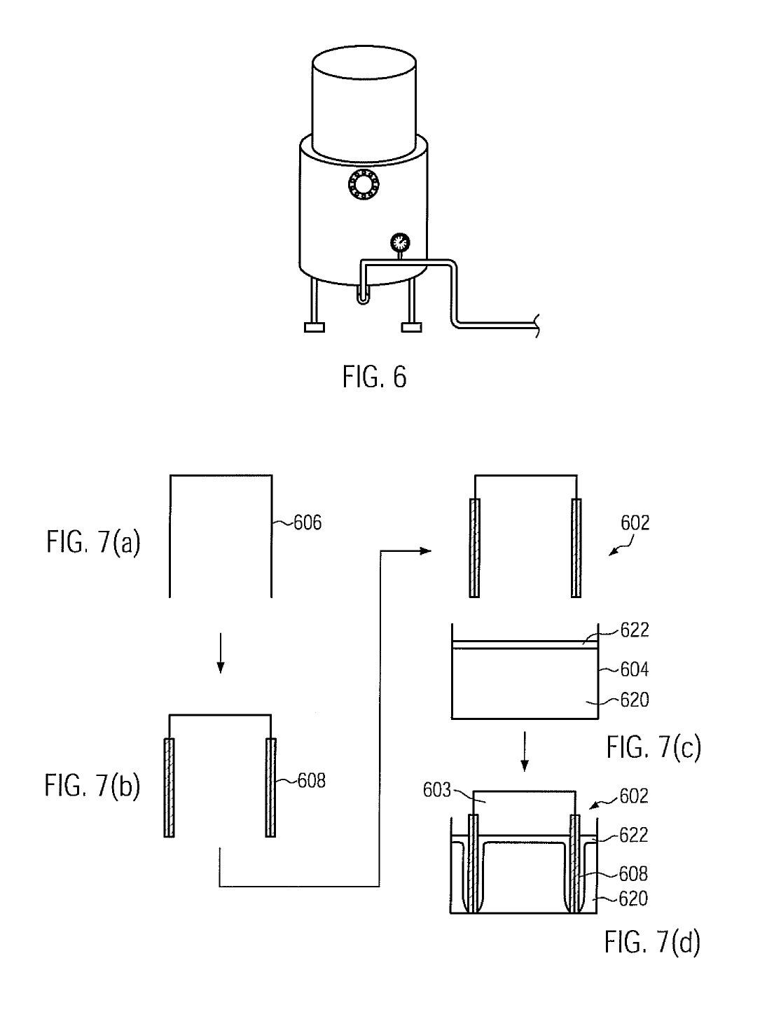

FIG. 6 shows a gas holder 602 and techniques for maintenance, according to a second embodiment of the invention, which is a complete view showing movable sections. This is the same as the first embodiment, except as described below. The sections include a base section 604 and upper section 606.

FIG. 7 shows schematically in cross-section the construction of the gas holder 602, showing a liquid sealing and the anti-corrosion coating in detail. As shown in FIG. 7(b), a first anti-corrosion coating 608 is optionally applied—this is the same coating as for the first embodiment. The base section 604 is partially filled with water 622 and a suitable quantity of Floatcoat® added as a second anti-corrosion coating 622 (FIG. 7(c)). In accordance with this embodiment, and as shown in FIG. 7(d), the assembled gas holder 602 provides a space 603 of variable volume for storage of gas.

It will be appreciated by skilled persons that numerous advantages are afforded by the invention and embodiments thereof. Application is extremely tolerant to adverse weather conditions and temperatures. Above freezing, there is no standing ice or risk of same. In humid conditions, there is no standing/surface water.

Trials show excellent corrosion protection achieved through a single application: tests showed no corrosion evident after 2.5 years. The average job duration was 8 to 13 weeks—50% of duration for conventional painting for first application. Duration for the second recoat is reduced—by preparation time of 1 to 2 weeks per lift (section) and possibly application of Performance 105 by roller.

Less material is required, reducing manual handling and use of portable plant. The details for a comparative test are as follows.
Conventional maintenance method (FIGS. 1-4): Primer/Finish—2300 litres.

Techniques according to embodiments of the invention:

“Performance 105”—400 litres

“Floatcoat”®—560 litres

Total 960 litres

i.e., 42% by volume of the materials for the conventional method, excluding any waste materials in conventional application.

The material poses minimum health hazards—requires only standard PPE for application, i.e., inhalation, COSHH (in the UK). The process poses minimum noise exposure—surface preparation is required on first application, however potentially not as stringent. Such noisy preparation is not required for future coatings, thus overall job duration is reduced further. The only requirement is to apply further quantities of the second anti-corrosion coating (e.g., Floatcoat®).

Various embodiments of the system are “self healing”, i.e., it requires minimal maintenance repairs—Mechanical damage to Performance105/Floatcoat does not travel under the surrounding surface. Surplus of the second anti-corrosion coating (e.g., Floatcoat®) on the tank/cup, or movement of surface Floatcoat®, will ‘self Heal” small areas of damage, i.e., carriage wear. Maintenance repair only requires minimum surface clean (degrease) and application of more of the second anti-corrosion coating (e.g., Floatcoat®).

It will be understood that it is not essential that the Performance 105 coating is applied. Floatcoat® affords sufficient anti-corrosion protection in its own right; however, an increased level of protection is afforded by utilising the hybrid system, and additionally a coloration can be provided through the Performance 105, which is not possible with Floatcoat® alone.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1.-24. (canceled)

25. A gas container, comprising:
at least a first section and a second section, the first and second sections being substantially hollow and movable relative to each other;
a liquid seal for sealing gas within the container, the liquid seal being disposed between the first section and the second section; and
a first anti-corrosion coating floating on the surface of the liquid in said liquid seal wherein the first anti-corrosion coating is applied to at least a portion of said second section during motion of the second section relative to the first section.

26. The gas container of claim 25, wherein the second section includes a second anti-corrosion coating on at least a portion thereof.

27. The gas container of claim 26, wherein the first anti-corrosion coating is applied to at least a part of said second anti-corrosion coating.

28. The gas container of claim 25, further comprising a number of further sections configured in a telescopic arrangement, wherein the volume of the gas container is variable and a liquid seal is provided between adjacent sections.

29. The gas container of claim 26, wherein at least one of the first and second sections include the second anti-corrosion coating on at least a portion thereof.

30. The gas container of claim 26, wherein the second anti-corrosion coating comprises a cured coating applied by painting or spraying.

31. The gas container of claim 25, wherein the first anti-corrosion coating comprises a floatable anti-corrosion coating.

32. The gas container of claim 25, wherein the liquid seal comprises a cup-shaped container having one of water and a water based liquid therein.

33. A method of assembling a gas container, comprising:
providing a first substantially hollow section;
providing a second substantially hollow section;
providing a liquid seal for sealing gas within the container, the liquid seal being disposed between the first section and the second section;
providing a first anti-corrosion coating so as to float on the surface of liquid in said liquid seal; and
causing the first and second sections to engage or move relative to each other, such that the first anti-corrosion coating is caused to be applied to at least a portion of said second section, during motion of the second section relative to the first section.

34. The method of claim 33, wherein the second section includes a second anti-corrosion coating on at least a portion thereof.

35. The method of claim 34, wherein the first anti-corrosion coating is caused to be applied to at least a part of said second anti-corrosion coating.

36. The method of claim 33, further comprising a number of further sections configured in a telescopic arrangement, wherein the volume of the gas container is variable and a liquid seal is provided between adjacent sections.

37. The method of claim 33, wherein at least one of the first and second sections include the second anti-corrosion coating on at least a portion thereof.

38. The method of claim 37, wherein the second anti-corrosion coating comprises a cured coating applied by painting or spraying.

39. The method of any of claim 33, wherein the first anti-corrosion coating comprises a floatable anti-corrosion coating.

40. The method of claim 33, wherein the liquid seal comprises a cup-shaped container having one of water and a water based liquid therein.

41. A method of maintaining a gas container, the container comprising a first section and a second section, the first and second section being substantially hollow and movable relative to each other; a liquid seal being provided for sealing gas within the container, the liquid seal being disposed between the first section and the second section, the method comprising:
providing a first anti-corrosion coating so as to float on the surface of the liquid of said liquid seal;
causing the first and second parts to engage or move relative to each other, wherein the first anti-corrosion coating is caused to be applied to at least a portion of said second section, during motion of the second section relative to the first section.

42. The method of claim 41, wherein the second section includes a second anti-corrosion coating on at least a portion thereof.

43. The method of claim 42, wherein the first anti-corrosion coating is caused to be applied to at least a part of said second anti-corrosion coating.

44. The method of any of claim 41, further comprising a number of further sections configured in a telescopic arrangement, wherein the volume of the gas container is variable; and a liquid seal is provided between adjacent sections.

45. The method of claim 41, wherein at least one of the first and second sections include the second anti-corrosion coating on at least a portion thereof.

46. The method of claim 45, wherein the second anti-corrosion coating comprises a cured coating applied by painting or spraying.

47. The method of any of claim 41, wherein the first anti-corrosion coating comprises a floatable anti-corrosion coating.

48. The method of claim 41, wherein the liquid seal comprises a cup-shaped container having one of water and a water based liquid therein.
